(19) United States
(12) Patent Application Publication
(10) Pub. No.: US 2026/0070354 A1
(43) Pub. Date: Mar. 12, 2026

(54) INKJET PRINTING APPARATUS, INKJET PRINTING METHOD, AND STORAGE MEDIUM

(71) Applicant: Konica Minolta, Inc., Tokyo (JP)

(72) Inventor: Satoru Shirasaka, Tokyo (JP)

(73) Assignee: Konica Minolta, Inc., Tokyo (JP)

(21) Appl. No.: 19/221,919

(22) Filed: May 29, 2025

(30) Foreign Application Priority Data
May 29, 2024 (JP) 2024-087172

(51) Int. Cl. B41J 13/00; B41J 2/21; B41J 11/00; H04N 1/00; H04N 1/60

(52) U.S. Cl. CPC B41J 13/0036; B41J 2/21; B41J 11/0095; B41J 13/009; H04N 1/00034; H04N 1/603

(57) ABSTRACT

Provided is an inkjet printing apparatus including: a printing section that produces a printed material; a first ejection section to which the printed material is ejected; and an in-line colorimeter that performs colorimetry on the printed material in a stopped state in the first ejection section.

### CROSS-REFERENCE TO RELATED APPLICATIONS

The entire disclosure of Japanese Patent Application No. 2024-087172 filed on May 29, 2024, is incorporated herein by reference in its entirety.

### BACKGROUND OF THE INVENTION

### Technical Field

The present invention relates to an inkjet printing apparatus, an inkjet printing method, and a storage medium.

### Description of Related Art

When colorimetry is performed on an inkjet printed material, it is necessary to wait until the ink dries and the color value stabilizes. For example, in the technique described in Japanese Unexamined Patent Publication No. 2010-241061, in a printing apparatus including a colorimeter installed in-line on a conveyance path of a printed material, colorimetry is performed after waiting for a drying time to elapse.

However, in a printing apparatus in which a colorimeter is installed on a conveyance path of a printed material, while waiting for stabilization of color values for colorimetry, a next print job, maintenance, or the like cannot be performed in some cases, and thus printing efficiency is low.

The present invention has been made in view of the above-mentioned situations. A problem to be solved by the present invention is to provide an inkjet printing apparatus, an inkjet printing method, and a non-transitory computer-readable recording medium storing a program, which are capable of achieving both colorimetry and efficient printing.

### SUMMARY OF THE INVENTION

To achieve at least one of the abovementioned objects, according to an aspect of the present invention, an inkjet printing apparatus reflecting one aspect of the present invention includes:
a printing section that produces a printed material;
a first ejection section to which the printed material is ejected; and
an in-line colorimeter that performs colorimetry on the printed material in a stopped state in the first ejection section.

According to another aspect of the present invention, an inkjet printing method includes:
printing to produce a printed material; and
performing colorimetry on the printed material in a stopped state in a first ejection section to which the printed material is ejected.

According to another aspect of the present invention, a non-transitory computer readable storage medium stores a program causing a computer of an inkjet printing apparatus to function as a controller, the inkjet printing apparatus including:
a printing section that produces a printed material; a first ejection section to which the printed material is ejected; an in-line colorimeter; and the computer,
wherein the controller causes the in-line colorimeter to perform colorimetry on the printed material in a stopped state in the first ejection section.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic configuration diagram of an embodiment of an ink jet printing apparatus;

FIG. 2 is a block diagram showing a functional configuration of the embodiment of the inkjet printing apparatus;

FIG. 3 is a flowchart showing an example of a colorimetry process; and

FIG. 4 is a flowchart showing an example of the colorimetry process.

### DETAILED DESCRIPTION

Hereinafter, one or more embodiments of the present invention will be described with reference to the drawings. However, the scope of the invention is not limited to the disclosed embodiments.

The following describes one or more embodiments of the present invention with reference to the drawings. The effects and features of the embodiments of the present invention will be understood from the following detailed description and the drawings. The following detailed description and drawings are provided for illustration only and do not limit the scope of the present embodiments.

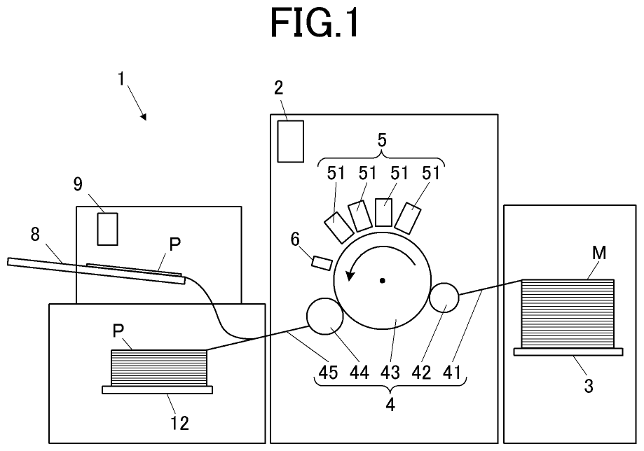

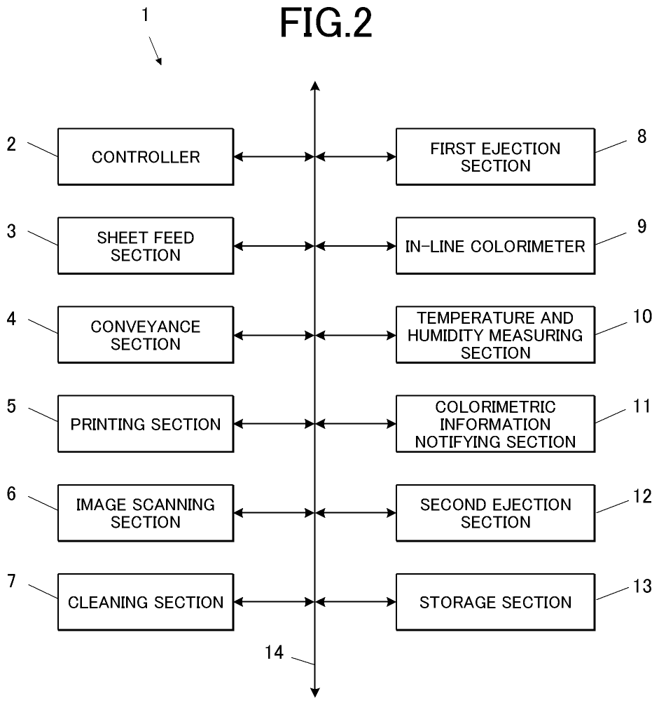

FIG. 1 is a schematic configuration diagram of an embodiment of an inkjet printing apparatus 1. FIG. 2 is a block diagram showing a functional configuration of the embodiment of the inkjet printing apparatus 1. The inkjet printing apparatus 1 according to the present embodiment includes a printing section 5, a first ejection section 8, and an in-line colorimeter 9. As shown in FIG. 1, the inkjet printing apparatus 1 may include a controller 2 (hardware processor), a sheet feed section 3, a conveyance section 4, an image scanning section 6, and a second ejection section 12. In addition, as shown in FIG. 2, the inkjet printing apparatus 1 may include a cleaning section 7, a temperature and humidity measuring section 10, a colorimetric information notifying section 11, a storage section 13, and a bus 14.

The sheet feed section 3 stores recording media M. The sheet feed section 3 includes, for example, a tray. As a recording medium M, various media can be used on which ink having landed on the sheet-like main surface can be fixed. Examples of the recording medium M include paper, fabric, and sheet-like resin. Examples of the paper include plain paper and coated paper. The recording medium M is preferably a cut sheet.

As shown in FIG. 1, the conveyance section 4 includes, for example, a feeder board 41, a first handover drum 42, a conveyance drum 43, a second handover drum 44, and an discharge unit 45.

The feeder board 41 conveys the recording medium M from the sheet feed section 3 to the first handover drum 42. The first handover drum 42 holds one end of the recording medium M conveyed by the feeder board 41, picks up the recording medium M, and transports the recording medium M to the conveyance drum 43.

The conveyance drum 43 has a columnar shape. A side circumferential surface of the conveyance drum 43 is a conveyance face that attracts and holds the recording medium M. The conveyance drum 43 rotates in one direction with the central axis as a rotation axis in a state where the recording medium M is held on the conveyance face. The conveyance drum 43 thereby conveys recording medium M, which is attracted to and held by the conveyance face, along the conveyance face.

The printing section 5 includes, for example, one or a plurality of head units 51. The printing section 5 performs a printing process (printing) of producing a printed material P by an inkjet method. Each of the head units 51 includes one or a plurality of inkjet heads. The head unit 51 has an ink ejection face at a position opposite the conveyance face of the conveyance drum 43. The head units 51 form an image by ejecting ink onto the recording medium M held by the conveyance drum 43 at appropriate timings corresponding to the rotation of the conveyance drum 43, thereby producing the printed material P. In the inkjet printing apparatus 1 shown in FIG. 1, four head units 51 are arranged at predetermined intervals in order from the upstream side in the rotation direction of the conveyance drum 43. The four head units 51 correspond to inks of four colors, for example, yellow, magenta, cyan, and black, respectively.

A normal job, a colorimetry job, and the like are performed in the printing section 5. A normal job is a print job for producing a normal printed material P that is not subjected to colorimetry. The colorimetry job is a print job for producing a printed material P to be subjected to colorimetry. The image formed by the colorimetry job may be a color chart or may be the same image as the image formed by the normal job. When the purpose of the colorimetry is image quality adjustment, the image formed by the colorimetry job is, for example, a color chart. When the purpose of the colorimetry is quality check, the image formed by the colorimetry job is, for example, the same image as the image formed by the normal job.

The image scanning section 6 irradiates the printed material P with light from a light source, and reads its reflected image. The image scanning section 6 is composed of, for example, an in-line sensor in which a plurality of detection elements are arranged along a direction (width direction) orthogonal to the conveyance direction of the recording medium M. Data of the image read by the image scanning section 6 is sent to, for example, the controller 2.

The cleaning section 7 performs cleaning of the head units 51 as maintenance. The cleaning section 7 is provided, for example, adjacent to the conveyance drum 43 in a direction in which the rotation axis of conveyance drum 43 extends. In this case, the cleaning section 7 performs cleaning on the head units 51 that have moved from the position opposite the conveyance drum 43. Examples of the cleaning include wiping for removing the ink adhering to the ink ejection face and purging for ejecting the ink inside the ink channel.

The second handover drum 44 holds one end of the printed material P conveyed by the conveyance drum 43, picks up the printed sheet P, and hands over the printed sheet P to the discharge unit 45.

The discharge unit 45 is a path of discharging the printed material P, and carries out the printed material P to the ejection sections such as the first ejection section 8 and the second ejection section 12. The discharge unit 45 is formed of, for example, a belt, a roller, and the like. In a case where there are a plurality of ejection sections, for example, in a case where the inkjet printing apparatus 1 includes the second ejection section 12 in addition to the first ejection section 8, the discharge path in the discharge unit 45 may be branched in the middle as shown in FIG. 1.

The printed material P is ejected to the first ejection section 8. The first ejection section 8 includes, for example, a tray. The in-line colorimeter 9 is located, for example, above the first ejection section 8. The in-line colorimeter 9 performs a colorimetry process (colorimetry). Specifically, the in-line colorimeter 9 performs colorimetry on the printed material P in a stopped state in the first ejection section 8 based on the control by the controller 2. The colorimetry is to measure color information, for example, to measure color values such as L*a*b* values. The in-line colorimeter 9 may be, for example, a spectral colorimeter that measures color by dispersing reflected light from the printed material P.

In a conventional printing apparatus in which a colorimeter is installed on a conveyance path of a printed material, while waiting for stabilization of color values for colorimetry, operations such as a next print job and maintenance cannot be performed, which results in low printing efficiency. On the other hand, in the inkjet printing apparatus 1 of the present embodiment, colorimetry is performed in the first ejection section 8. Accordingly, in the inkjet printing apparatus 1 of the present embodiment, it is easy to perform operations such as a next print job or maintenance even during standby for colorimetry and/or during colorimetry. Therefore, according to the inkjet printing apparatus 1 of the present embodiment, it is possible to achieve both colorimetry and efficient printing. In addition, since the colorimeter is not a colorimeter installed outside the inkjet printing apparatus 1 but the in-line colorimeter 9 included in the inkjet printing apparatus 1, it is easy to control the printing process and the colorimetry process. In addition, since the colorimetry is performed on the printed material P in a stopped state, the accuracy of the colorimetry increases as compared with a case where the colorimetry is performed on a moving printed material P.

The “colorimetry on the printed material P in the stopped state” according to the present embodiment also includes colorimetry by repeating the colorimetry on a part of the printed material P in the stopped state and the movement of the printed matter P. For example, first, while the in-line colorimeter 9 scans in the direction orthogonal to the conveyance direction of the printed material P, colorimetry is performed on the first row of the printed matter P in a stopped state. The row of the printed material P at this time is, for example, a range in which the in-line colorimeter 9 can perform colorimetry by one-time scanning. When the colorimetry for the first row of the printed material P is completed, the printed material P moves by one row in the first ejection section 8. Next, while the in-line colorimeter 9 scans again in the direction orthogonal to the conveyance direction of the printed material P, colorimetry is performed on the second row adjacent to the first row of the printed sheet P in the stopped state. When the colorimetry for the second row of the printed material P is completed, the printed matter P moves by one row in the first ejection section 8 again. In this way, the colorimetry according to the present embodiment does not needs to be performed at once on the printed material P in a stopped state, and may be performed while the stop and movement of the printed material P are repeated.

The color value of the printed material P ejected to the first ejection section 8 may not be stable immediately due to the reason that the ink is not dried yet or the like. Therefore, the colorimetry may be performed after a predetermined colorimetry standby time has elapsed since the printed material P is ejected to the first ejection section 8.

The colorimetry standby time may be adjusted according to at least one of the paper type and the paper thickness of the printed material P. The colorimetry standby time may be adjusted according to at least one of the ink type, the image density, and the ink amount on the printed material P. The ink amount may be the ink amount of the entire printed material P, or may be the maximum ink amount per unit area of the printed material P. The colorimetry standby time may be adjusted according to at least one of the paper surface temperature of the printed material P during printing, the temperature of the first ejection material 8, and the humidity of the first ejection section 8. The adjustment of the colorimetry standby time may be performed by the user or may be performed based on the control by the controller 2.

The temperature and humidity measuring section 10 is provided in the vicinity of the first ejection section 8 and measures the temperature and/or humidity of the first ejection section 8. The temperature and/or humidity of the first ejection section 8 measured by the temperature and humidity measuring section 10 is used, for example, to adjust the colorimetry standby time.

The colorimetric information notifying section 11 notifies the colorimetric information obtained by the in-line colorimeter 9, for example, by a method of displaying the colorimetric information on a display. The colorimetric information notified by the colorimetric information notifying section 11 is, for example, information on whether or not a change (variation) in the color values of the printed material P exceeds an allowable value.

The printed material P is ejected to the second ejection section 12. The second ejection section 12 is an ejection section provided separately from the first ejection section 8. The second ejection section 12 includes, for example, a tray. In a case where the inkjet printing apparatus 1 further includes the second ejection section 12 in addition to the first ejection section 8, for example, only the printed material P to be subjected to colorimetry is ejected to the first ejection section 8, and normal printed matter P not to be subjected to colorimetry is ejected to the second ejection section 12.

The controller 2 controls operation of the other functional components in accordance with print image data, print settings, and the like. The controller 2 is a computer, and includes, for example, a central processing unit (CPU), a random access memory (RAM), and a read only memory (ROM). The CPU executes various control programs to drive and control the inkjet printing apparatus 1 and performs various calculation processes. The RAM provides a working memory space for the CPU and stores temporary data. The RAM may include a nonvolatile memory. The ROM stores various control programs to be executed by the CPU, setting data, and the like. Instead of the ROM, a rewritable nonvolatile memory such as a flash memory may be used.

The storage section 13 stores programs executed by the CPU, various types of setting data, and the like. As the storage section 13, for example, a hard disk drive (HDD) is used, and a dynamic random access memory (DRAM) or the like may be used together.

The bus 14 is a channel for communication of signals between the controller 2 and other functional components. Each functional component may operate based on control signals transmitted from a processor separate from the controller 2.

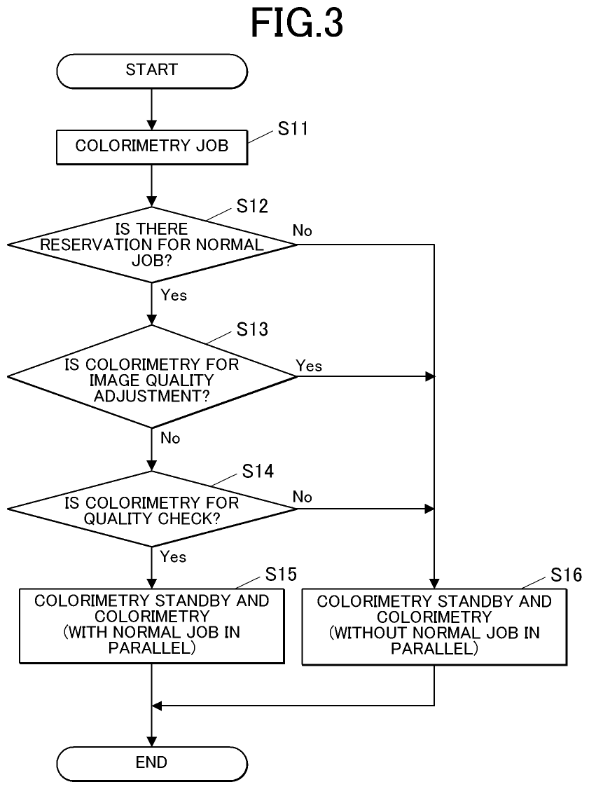

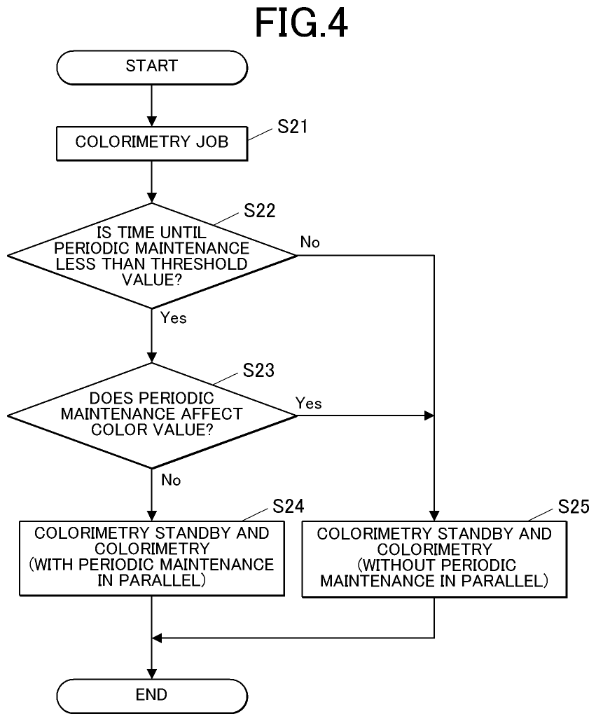

Next, an example of a flow of the colorimetry process in the inkjet printing apparatus 1 of the present embodiment will be described with reference to FIGS. 3 and 4.

FIG. 3 is a flowchart according to an embodiment in which, when a normal job is reserved after a colorimetry job, it is determined, depending on the purpose of colorimetry, whether or not to perform the normal job during standby for colorimetry and/or during colorimetry.

### Step S11

In Step S11, a colorimetry job is performed by the printing section 5. As described above, the image formed on the printed material P in the colorimetry job is, for example, a color chart when the purpose of colorimetry is image quality adjustment, and is, for example, the same image as the image formed in the normal job when the purpose of colorimetry is quality check.

### Step S12

After the colorimetry job is performed in Step S11, the flow proceeds to Step S12. In Step S12, the controller 2 determines whether a normal job is reserved.

### Step S13

If it is determined in Step S12 that a normal job is reserved, the flow proceeds to Step S13. In Step S13, the controller 2 determines whether or not the purpose of colorimetry is image quality adjustment.

### Step S14

If it is not determined in Step S13 that the purpose of the colorimetry is image quality adjustment, the flow proceeds to Step S14. In Step S14, the controller 2 determines whether the purpose of the colorimetry is quality check.

### step S15

If it is determined in Step S14 that the purpose of colorimetry is quality check, the flow proceeds to Step S15. In Step S15, standby for colorimetry and colorimetry are performed by the in-line colorimeter 9, and in parallel with the standby for colorimetry and the colorimetry, a normal job is performed by the printing section 5. That is, in Step S15, the normal job is performed during standby for colorimetry and/or during colorimetry. The number of printed materials P produced in the normal job may be one or more.

When a plurality of printed materials P are produced in a normal job, the plurality of printed matters P can be continuously produced. As a result of the colorimetry, when the variation in the color value exceeds the allowable value, the printing section 5 may temporarily stop the normal job under the control of the controller 2. The variation in the color value is, for example, a difference between a set value and a measured value of the color value. At this time, the colorimetric information notifying section 11 may notify, under the control of the controller 2, the printed material(s) P prepared during a period from the colorimetry job to the suspension of the normal job as the print quality unattained sheet. This allows easy identification of the printed material P that is likely to have a variation in color value exceeding the allowable value, while performing the normal job during colorimetry and/or colorimetry.

### Step S16

If it is not determined in Step S12 that a normal job is reserved, if it is determined in Step S13 that the purpose of colorimetry is image quality adjustment, or if it is not determined in Step S14 that the purpose of colorimetry is quality check, the flow proceeds to Step S16. In Step S16, the in-line colorimeter 9 waits for colorimetry and performs colorimetry, but the printing section 5 does not perform a normal job in parallel with standby for colorimetry and colorimetry. That is, in Step S16, the normal job is not performed during standby for colorimetry and/or during colorimetry.

When the colorimetry is performed in Step S15 or Step S16, the colorimetry process ends. After the colorimetry process is finished, for example, a normal job is performed, and the colorimetry process may be performed again as necessary after or during the normal job.

The inkjet printing apparatus 1 according to the embodiment described above can perform the normal job even during standby for colorimetry and/or during colorimetry, thus achieving both colorimetry and efficient printing.

FIG. 4 is a flowchart in an embodiment in which periodic maintenance is performed during standby for colorimetry and/or during colorimetry in a case where the time until periodic maintenance that does not affect the color value of the printed material P is less than a threshold value.

### Step S21

In Step S21, as in Step S11, the printing section 5 performs a colorimetry job for producing a printed material P to be subjected to colorimetry.

### Step S22

After the colorimetry job is performed in Step S21, the flow proceeds to Step S22. In Step S22, the controller 2 determines whether a time until periodic maintenance is less than a threshold value. The interval and the threshold value of the periodic maintenance are set values predetermined by the user, for example.

### Step S23

If it is determined in Step S22 that the time to the periodic maintenance is less than the threshold value, the flow proceeds to Step S23. In Step S23, the controller 2 determines whether the periodic maintenance does not affect the color value. The periodic maintenance that does not affect the color value is, for example, wiping to remove ink adhered to the ink ejection face, purging to eject ink inside the ink channel, adjustment of the conveyance section 4, or the like.

### Step S24

If it is determined in Step S23 that the periodic maintenance does not affect the color value, the flow proceeds to Step S24. In Step S24, standby for colorimetry and colorimetry are performed by the in-line colorimeter 9, and the periodic maintenance is performed in parallel with the standby for colorimetry and the colorimetry. That is, in Step S24, the periodic maintenance is performed during standby for the colorimetry and/or during the colorimetry.

### Step S25

If it is not determined in Step S22 that the time to the periodic maintenance is less than the threshold value, or if it is not determined in Step S23 that the periodic maintenance does not affect the color values, the flow proceeds to Step S25. In Step S25, the standby for colorimetry and colorimetry are performed by the in-line colorimeter 9, but the periodic maintenance is not performed in parallel with the standby for colorimetry and the colorimetry. That is, in Step S25, the periodic maintenance is not performed during standby for the colorimetry and/or during the colorimetry.

When the colorimetry is performed in Step S24 or Step S25, the colorimetry process ends. After the colorimetry process is finished, for example, a normal job is performed, and the colorimetry process may be performed again as necessary after or during the normal job.

The inkjet printing apparatus 1 according to the present embodiment described above can perform maintenance even during standby for colorimetry and/or during colorimetry, thus achieving both colorimetry and efficient printing.

The inkjet printing method of the present embodiment includes a printing process (printing) in which the printed material P is produced, and a colorimetry process (performing colorimetry) in which colorimetry is performed on the printed material P in a stopped state in the first ejection section 8 to which the printed material P is ejected.

The program of the present embodiment is a program that causes a computer in the above-described inkjet printing apparatus 1 to function as the controller 2. The computer functioning as the controller 2 by the program controls the inkjet printing apparatus 1 as described above.

The above description and drawings are only for purposes of illustrating and exemplifying embodiments of the present invention and are not intended to limit the scope of the present invention. The scope of the present invention should be interpreted by the terms of the claims.

Although embodiments of the present invention have been described and shown in detail, the disclosed embodiments are made for purposes of illustration and example only and not limitation. The scope of the present invention should be interpreted by terms of the appended claims.

What is claimed is:

1. An inkjet printing apparatus comprising:
a printing section that produces a printed material;
a first ejection section to which the printed material is ejected; and
an in-line colorimeter that performs colorimetry on the printed material in a stopped state in the first ejection section.

2. The inkjet printing apparatus according to claim 1, further comprising:
a second ejection section to which the printed material is ejected, separately from the first ejection section,
wherein after the printed material is ejected to the first ejection section and then a predetermined colorimetry standby time has elapsed, the in-line colorimeter performs the colorimetry.

3. The inkjet printing apparatus according to claim 2,
wherein the colorimetry standby time is adjusted according to at least one of a paper type and a paper thickness of the printed material.

4. The inkjet printing apparatus according to claim 2,
wherein the colorimetry standby time is adjusted according to at least one of a type of ink, image density, and an ink amount of the printed material.

5. The inkjet printing apparatus according to claim 2,
wherein the colorimetry standby time is adjusted according to at least one of a paper surface temperature of the printed material during printing, a temperature of the first ejection section, and a humidity of the first ejection section.

6. The inkjet printing apparatus according to claim 2,
wherein when a normal job of producing the printed material not to be subjected to the colorimetry is reserved after a colorimetry job of producing the printed material to be subjected to the colorimetry, it is determined, according to a purpose of the colorimetry, whether or not the normal job is to be performed during standby for the colorimetry and/or during the colorimetry.

7. The inkjet printing apparatus according to claim 6,
wherein when the purpose of the colorimetry is image quality adjustment, the normal job is not performed during standby for the colorimetry and/or during the colorimetry.

8. The inkjet printing apparatus according to claim 6,
wherein when the purpose of the colorimetry is quality check, the normal job is performed during standby for the colorimetry and/or during the colorimetry.

9. The inkjet printing apparatus according to claim 8,
wherein, with a variation in color value exceeding an allowable value according to a result of the colorimetry, the normal job is put on suspension, and the printed material produced during a period from the colorimetry job to the suspension is notified as a print quality unattained sheet.

10. The inkjet printing apparatus according to claim 1,
wherein, with the time until a periodic maintenance that does not affect a color value of the printed material being less than a threshold value, the periodic maintenance is performed during standby for the colorimetry and/or during the colorimetry.

11. An inkjet printing method comprising:
printing to produce a printed material; and performing colorimetry on the printed material in a stopped state in a first ejection section to which the printed material is ejected.

12. A non-transitory computer readable storage medium storing a program causing a computer of an inkjet printing apparatus to function as a controller, the inkjet printing apparatus comprising:
a printing section that produces a printed material; a first ejection section to which the printed material is ejected; an in-line colorimeter; and the computer,
wherein the controller causes the in-line colorimeter to perform colorimetry on the printed material in a stopped state in the first ejection section.
